(19) United States
(12) Patent Application Publication
(10) Pub. No.: US 2017/0347662 A1
(43) Pub. Date: Dec. 7, 2017

(54) Means for Storage, Transport and Biocide Treatment of Liquids, Pastes and Gels

(71) Applicant: Metalskin Technologies SAS, Balaruc-Bains (FR)

(72) Inventor: Stephane Penari, Balaruc-Les-Bains (FR)

(21) Appl. No.: 15/544,300

(22) PCT Filed: Jan. 19, 2016
(86) PCT No.: PCT/EP2016/051012

§ 371 Date: Jul. 18, 2017

(30) Foreign Application Priority Data
Jan. 19, 2015 (EP) 15305055.4

(51) Int. Cl. A01N 59/20; C02F 1/50; A01N 25/08; A01N 59/26; C10G 75/00

(52) U.S. Cl. CPC A01N 59/20; A01N 59/26; C10G 75/00; A01N 25/08; C02F 1/50; C02F 2303/20; C02F 2303/04

(57) ABSTRACT

The subject matter of the present invention concerns means of storage, transport and/or biocide treatment of a liquid, paste or gel, characterized in that said means comprises a copper base powder composition, said composition: containing at least 60% by weight of copper, does not contain more than 70% by weight of powder particles whose diameter is less than 45 μm maximum, and is at least partially in contact with said liquid, paste or gel.

The subject matter of the present application concerns means for storage, transport and/or treatment of a liquid, paste or gel, using copper powder or copper derivatives powder as active ingredient and wherein said means have biocide activities.

### BACKGROUND OF THE INVENTION

At the dawn of the 80s, a new technique appeared and revolutionized the way the world works with metal. This technique, which is schematically the association of a metal powder composition with a binder, allows to quickly cover virtually any support, regardless of the form or nature of said support reproducing every details of the support.

This true composite material solves many problems of implementation of solid metal, in particular, costs and workability. Patent applications FR1357099, FR1400766, and PCT EP2014/065498, which contents are incorporated to the present application by reference, disclosed that oxidized or phosphorus-copper had particularly good biocide properties, specifically when they were incorporated into a binder as described above. For instance, it was shown in the examples disclosed that these derived-copper powders had better biocide properties than pure copper, which moreover is unaesthetic. However, the pure copper powder still has the wanted biocide effect, in particular when it is in the binder.

Identified background art concerns copper oxide for antifouling applications, without however specifying the right granularity (U.S. Pat. No. 2,420,540), or welding powders, which however do not specify the right granularity to be incorporated into composites.

However new uses of these powders have been specifically and surprisingly identified by the Applicant. The copper composite used in the present invention, and thus the powder it retains, in means of storage and supply enables to kill at least a proportion of the microorganisms contained in the liquid, paste and gel transported or stored to which the means are exposed. This also enables to preserve said means of storage and supply as the bio-corrosion is limited if not totally eliminated. It is also possible to use the present technology for simple flow-through filters to kill microorganisms contained in liquids, pastes or gels, independently of the nature of said liquid, paste or gel.

### SUMMARY OF THE INVENTION

The subject of the present invention is based upon:
a powder composition of copper (e.g. oxidized and/or phosphorus, preferably in the form of CuP₈), characterized in that said powder contains at least 60% by weight of copper, and does not contain more than 70% by weight of particles whose diameter are equal to 45 μm or less;
a method for producing said oxidized copper composition, is characterized in that the copper is heated at a temperature of at least 500° C. in the presence of oxygen and/or a source of oxygen, preferably in the presence magnesium or phosphor;
the use of said composition as a biocide;
the use of said composition to slow or prevent the bio-corrosion of a substrate preferably by coating said substrate with said composition;
a composite characterized in that it comprises a powder of said composition, a binder and optionally a curing catalyst agent;
a method of manufacturing said composite wherein the powder composition is mixed at room temperature (i.e. 20 to 25° C., preferably 25° C.) with the binder in the liquid state, then a curing catalyst is added if necessary;
the use of said composite, for the coating of a substrate or the molding of a substrate;
a method for manufacturing a surface coating, characterized in that said composite is sprayed onto the surface of a substrate, or the substrate is dipped in said composite (i.e. in the liquid state);
a surface coating obtainable by the above method;
the use of said surface coating as a biocide, preferably to avoid bio-corrosion.

Moreover, the subject matter of the present application more specifically concerns means of storage, transport and/or biocide treatment of a liquid, paste or gel, characterized in that said means comprises a copper base powder composition, said composition:
containing at least 60% by weight of copper,
does not contain more than 70% by weight of powder particles whose diameter is less than 45 μm maximum, and
is at least partially in contact with said liquid, paste or gel.

The subject matter of the present application also concerns the use of the means of storage, supply and/or biocide treatment according to the present invention for reducing the population of microorganisms contained in a liquid, paste or gel, preferably to sterilize said liquid, paste or gel, or to ensure said liquid, paste or gel is sterile.

The subject matter of the present application moreover concerns the use of the means of supply of a liquid, paste or gel according to the present invention to increase the transport speed of said liquid, paste or gel, as compared to a transport means which does not use such a composite or coating with the same energy expenditure.

The subject matter of the present application moreover concerns the use of the means of supply of a liquid, paste or gel according to the present invention to reduce the expenditure of energy associated with the flow of said liquid, paste or gel, compared with a transport means which does not use such a coating or composite.

### DEFINITIONS

In the context of the present invention it is meant by “means of storage, transport and/or treatment” one or several container(s) adapted to comprise, sustain or flow through or upon, one or several liquids, gels or pastes, said container(s) having at least one surface comprising the copper base powder of the invention, preferably immobilized in a binder. The container(s) can be sealed, or can comprise at least one entrance and/or one exit for the liquid, gel or paste to go through. Typically these means will be tanks, pipes and/or filters.

A powder is a split state of matter. It is thus a plurality of units (or parts / granules) of solid mater (s) with a size generally less than a tenth of a millimeter (100 microns) which together constitute a “collection”. A powder is characterized in terms of its physical properties by dispersion of sizes, i.e. granularity.

Granularity is the extent to which a system is broken down into small parts. It is thus the study of the statistical distribution of the particle sizes of a plurality of solid units (or parts/granules). The particle size analysis is the set of operations to determine the size distribution of the components of a powder. Granularity can be represented with a table of numbers or graphs representing the particle size distribution of a powder.

The braking down into copper powder (oxidized and/or phosphorus) for the present invention may be done by any method known in the art, such as by mechanical, chemical, physical braking down (“fractionation”). It is possible to obtain the desired powder according to the present invention by a direct appropriate braking down technic, which requires the control of said technic by the operator, which nevertheless belongs to the common knowledge in the art. Possibly, the wanted powder can be obtained by any crude fractionation technic known in the art, optionally followed by the passage on two different molecular sieves to ensure that the size of particles constituting the powder are not too small or too large, thus ensuring the perfect control of the essential features necessary for carrying out the present invention. Thus, it is clear in the context of the present invention of the possibility of adding other compounds / powders such as metallic powders to obtain a “blend” composition, with the technical effects described herein in addition to other effects brought by the secondary compounds / powders added.

Thus, one embodiment of the present patent application relates to a method of manufacturing a composition according to the present invention characterized in that the copper powder (oxidized and/or phosphorous) is obtained by direct fractionation (preferably, the fractionation is done by an atomization technique, for example with water e.g. after metal fusion) or by reconstituting the powder blend. These technics are extremely common in the art. Advantageously the particles obtained by such techniques are between 8 and 150 microns (D50) and the amount of oxygen included in the composition can be between 0.3 and 5% by weight.

Atomization is not the sole technology available to produce the metallic powder used in the present invention. As a matter of fact, U.S. Pat. No. 2,420,540 discloses grinding & milling technology which allows to obtain wide range of granulometry (see in particular col 3, lines 45-60 as well as col 6, lines 50-75).

The fractionation of powder can be done by any technique known in the art, either by mechanical, chemical or physical fractionation, etc. It is possible to obtain the desired powder according to the present invention directly by a fractionation adequate, which implies a control of the technology by the operator who is nevertheless a common knowledge in the art. It is also well known in the art that an easier alternative technique is to split the material coarse and a it regular according to particle size, and then by the operation of successive sieving, isolate populations of special powders (i.e. presenting specific grits and regular). In the framework of the present invention the following technique is quite applicable: a gross fractionation may be operated, followed by a step of sampling and isolation of special powders, then a step of selection of powders in order to reconstitute the powder according to the invention. These techniques are extremely common in the art. The control of the particle size distribution is in fact part of the general knowledge of a person skilled in the art. As well, it is obvious in the context of the present invention to add other compounds/powder such as metal powders in order to obtain a “mixed” composition presenting technical effects described currently in addition of other effects brought by the added compounds/secondary powders. As well, a mode of realization of the present patent application relates to a process for the manufacture of a composition according to the present invention characterized in that the powder of oxidized copper is obtained directly by the fractionation or is reconstituted from several powders of determined granulometries and proportions of copper. Advantageously, powders to the granulometries determined have been obtained by any of the fractionation techniques known in the art, followed by at least two passages on molecular sieves to ensure that the size of the particles constituting the powder are neither too small, or too large, thus ensuring the perfect control of essential characteristics necessary to the implementation of the present invention. In addition, the techniques of determination of the rate of copper are extremely common in the art and may be made by chemical and/or physical methods.

Nevertheless and preferentially, fractionation can be done by a technique of atomization, for example water atomization (following metal fusion). In an advantageous manner the particles obtained by such techniques are in the range of between 8 and 150 μm.

In any case, metal powders, copper powders, or phosphorous-copper powders represent commodities in the metal industries and can be purchased in the trade from any manufacturer. As a matter of example, POUDMET (26 Rue du Moulin Sénécourt F-60140 BAILLEVAL. France) is company specialized in the manufacture and distribution of metal powders, including copper, bronze, tin, brass, copper-phosphorous powders as well as alloys of various ranges from 4 to more than 200 μm according to various technologies such as water atomization, air atomization and milling for example. Thus metal powders used in the present invention can be obtained directly from metal powders manufacturers and POUDMET is one of these.

According to one embodiment of the present invention, the expression “oxidized copper powder”, concerns a powder which has the granular characteristics presently defined (to enable incorporation into a binder), and that the powder has a content of oxidized copper greater than or equal to 5% by mass of the total mass of copper in the powder preferably greater or equal 10%, 20%, 30%, 40%, 50%, 60%, 70%, 80%, 90%, 95%, 99% or 100% by mass of the total mass of the copper powder.

By “phosphorus-copper powder”, it is understood according to the present invention, firstly, that the powder has the granular characteristics presently defined, and secondly that the powder has a phosphorus content between 2 and 16% by weight, preferably 8%. Preferably, the phosphorus-copper powder consists of an alloy of copper and phosphor, preferably CuP₈, preferably at a copper: phosphorus percentage content equal to or greater than 84:16% by mass, 85% 15, 90:10% 95:5% 98:2% 99:1%, more preferably greater than or equal to 92: 8% by mass. Preferably, the powder comprising phosphorus-copper comprises CuP₈ as the major component in the composition equal or less than 50%, 60%, 70%, 80%, 90%, 95%, 99% by total weight of powder, or the powder consists of CuP₈.

The definition of the term “biocide” according to the present invention is that of the Directive 98/8/EC of the European Parliament and of the Council of 16 Feb. 1998 concerning the placing of biocidal products on the market (OJ No L 123 of 24 Apr. 1998).

The term “bio-corrosion” of the present invention relates to corrosion of materials directly or following the action of living organisms. These organisms may be microscopic or macroscopic, unicellular or multicellular, such as bacteria, algae, fungi, mollusks, etc.

A binder (or “binding agent”) according to the present invention relates to a product which binds molecules of a member to another element, optionally melting materials with heat if need-be. For example, in the present case, the binder will fix the powder particles in a rigid matrix which can be polymeric.

The curing catalyst enables the acceleration or even the feasibility of the polymerization in a matrix which finally can be hard or flexible. The catalyst may be replace/helped by a treatment with heat. The polymer is often prepared by crosslinking two ingredients, one of which is typically a “resin”, typically reacting under the action of heat in the presence of reagents (polymerization catalyst and accelerator). The stable three-dimensional structure (network) formed generally has a thermomechanical and chemical resistance.

A composite is a combination of two materials of different natures. In the present invention, it is the combination of the particles of a metal powder in an organic or inorganic fixed matrix, which may still allow for mechanical flexibility if desired.

A particular embodiment of the present application concerns the means of storage, transport and/or biocide treatment of a liquid, paste or gel, according to the present invention, characterized in that the composition of copper powder is comprised in a surface coating. A coating (also called thin layer when its thickness is between a few microns and a few hundred microns) aims to improve the surface properties of an object. For example and in general, the coatings can be used to preserve or enhance the appearance, adhesion, corrosion resistance, bring special properties of wettability or adjust the surface properties of the considered object to face mechanical stress and various elements of the external environment (ultraviolets, water, oxidation (corrosion), temperature variations...). The surface coating according to the present invention can be used without limitation in various thicknesses and resins generally applied as already found on the market. In addition, the composite according to the present invention may be sprayed in a thin layer of a few microns. Thus the coating according to the present invention can have a varying thickness of a few microns to a few centimeters. The coating thickness is preferably comprised in the range 10 μm to 15 cm, 50 μm to 5 cm, 100 μm to 1 cm, 150 μm to 1 mm, such as 200 μm or 500 μm to 1 mm.

Any physical or physico-chemical technic applicable in the present case and known to those skilled in the art can be used to produce the coating. Moreover, the obtained coating in contact with the free surface of the substrate according to the method of the present invention may have a substantially constant thickness.

The term “substrate” means a solid support on which will be deposited at least one layer of coating according to the invention. This support may be of any kind of material, natural or synthetic, organic, inorganic or inorganic, crystalline, polycrystalline and/or amorphous material.

By “fluid” is understood according to the present invention, any substance that deforms continuously under shear stress applied thereto. A liquid, paste or gel can all be considered as fluids in the context of the present invention.

Therefore, a particular embodiment of the present application concerns the means of storage, transport and/or biocide treatment of a liquid, paste or gel, of the present invention, characterized in that the liquid, paste or gel is organic and/or inorganic, preferably food and/or beverages or intended for pharmaceutical purposes, cosmetic purposes or fuel, preferably selected from crude or refined oil, water, fuel for vehicles such as diesel fuel, kerosene or unleaded fuel.

The term “spraying” (or spray) according to the present application relates to the production of a cloud of droplets, i.e. containing micro or nano-sized droplets suspended in the gas and which optionally contains the vehicle or the space containing them (in the case of an ultrasonic nozzle). The “nozzle” is the device that allows such spraying.

By “Oxidation to the heart”, it is understood according to the present invention, that the particles of the copper powder are oxidized both at the surface and at the center of the particles. Indeed, the subject matter of the present invention also concerns a means of storage, transport and/or biocide treatment of a liquid, paste or gel, characterized in that the copper is immobilized (i.e. with respect to said means means of storage, transport and/or biocide treatment), oxidized (preferably to the heart of the particles) and/or comprises phosphor (preferably in the form of phosphorous copper such as CuP₈). The rate of oxidation may however vary in a straight line that goes from the surface of the particle to the center thereof (that is to say, the center of gravity) of the particle. Typically the particle surface can be more oxidized than the center. Advantageously, the center has an oxidation rate that is 50% by mass lower than that of the surface, more preferably the center has an oxidation rate is 25% by mass lower than that of the surface, more preferably the center has an oxidation rate is 10% by mass lower than that of the surface, the more advantageously the center has an oxidation rate which is identical to that of the surface.

In general, the oxidation involves a loss of electrons from the oxidized entity. This results for copper in the development reaction with oxygen when present. For example in the case where the powder initially contains only copper, the rate of oxidation according to the present invention then refers to the original quantity by weight of copper in the zero oxidation state (“Cu⁰”) which is oxidized into CuO, wherein the copper is at an oxidation state +2. In general the rate of oxidation thus refers to the amount of copper which is oxidized and thus to a ratio of amounts (determined by mass, mole . . . ) of copper which is engaged in the oxidation reaction.

In the context of the present invention, “expenditure of energy” refers to the amount of energy (measured in whatever convenient unity such as in joules, watts, calories etc.) to circulate the liquid, past or gel through or on the means of storage, transport and/or biocide treatment of the present invention per unit of length (measured in whatever convenient unity such as kilometers, meters, centimeters, etc).

In the context of the present invention, a tanker vehicle is a vehicle such as a boat, airplane, truck or trailer, which has at least one liquid (such as fuel), gel or paste container which is not necessarily linked to the means of movement (i.e. motor) of said vehicle. In the context of the present invention, a fuel tank is the fuel container linked to the means of movement (i.e. motor) of the vehicle (e.g. a boat, plane, car, bus, truck, etc.).

### DETAILED DESCRIPTION OF THE INVENTION

In a particular embodiment of the present application, the means of storage, transport and/or biocide treatment of a liquid, paste or gel of the invention is characterized in that the oxidation of copper is greater than 95% by weight of oxidized copper vis-à-vis the total weight of copper and/or that the amount of phosphorus is between 2 and 16%, preferably 8%, by weight vis-à-vis the total weight of the powder composition. More particularly, the subject of the present invention relates to a powder composition of (oxidized and/or phosphorus) copper as defined above wherein the copper mass is greater than or equal to 65%, 70%, 75%, 80%, 85%, 90%, 95%, 97%, 98%, 99%, 99.5%, or 99.9% by weight of the powder composition.

Another factor to be taken into consideration is the granularity of the powder. Indeed, completely independently of the amount of copper contained in the (oxidized and/or phosphorus) copper powder. If the copper powder is too fine, contrary to what could be expected, the composite does not form properly and it thus presents unacceptable physico-chemical properties (hardness, friability, flexibility, etc.). Advantageously, in the case of pure CuP₈ powder, the granularity is not of 200 mesh (74 μm).

In one particular embodiment, copper powder (e.g. oxidized and/or phosphorus) contains no more than 65% by weight of particles whose diameter is less than 45 μm in maximum. Advantageously, the powder particles are all below 250 μm in diameter, 200 μm, 150 μm, 125 μm, 110 μm, 100 μm, 95 μm, 90 μm, 85 μm, 80 μm, 70 μm, 65 μm or 60 μm.

According to a particular embodiment of the invention, the powder is of the following granularity (i.e. particles of different diameters D):
1±1% by weight of particles of diameter D1: 125 μm≦D1
2±2% by weight of particles of diameter D2: 106 μm≦D2<125 μm
12±10% by weight of particles of diameter D3: 75 μm≦D3<106 μm
10±5% by weight of particles of diameter D5: 63 μm≦D5<75 μm
20±10% by weight of particles of diameter D6: 45 μm≦D6<63 μm
40±30% by weight of particles of diameter D7: D7≦45 μm

According to an advantageous embodiment of the invention, the powder is of the following granularity (i.e. particles of different diameters D):
1.0% by weight of particles of diameter D2: 106 μm≦D2
8.1% by weight of particles of diameter D3: 75 μm≦D3<106 μm
7.9% by weight of particles of diameter D5: 63 μm≦D5<75 μm
19.2% by weight of particles of diameter D6: 45 μm≦D6<63 μm
63.8% by weight of particles of diameter D7: D7≦45 μm

Typically, the weight percentages are added-up to a cumulative particle granularity according to ISO 4497. It is easy for those skilled in the art in view of the above data ranges to simply add the values to find the current standards of granularity (cumulative).

Regarding the density of the compositions, in general, it is between 1 and 5 g/cm³, more particularly between 1.5 and 3 g/cm³, between 1.5 and 2 g/cm³, between 2 and 3 g/cm³, between 2 and 2.5 g/cm³, between 2.5 and 3 g/cm³.

The composition of copper (oxidized and/or phosphorus) powder of the present invention may be characterized in that said composition comprises at least one metal other than copper, preferably selected from the group consisting of magnesium, tin, technetium, rhenium, iron, chromium, cobalt, zinc, platinum, cadmium, aluminum, nickel, silver, beryllium, calcium, strontium, and/or at least one nonmetal inorganic compound such as nitrogen, arsenic, sulfur, fluorine, chlorine, bromine, carbon, silicon.

Another subject of the present invention relates to a method of manufacturing a composition as defined above, characterized in that the copper is oxidized at a temperature less than 500° C., 800° C., 1000° C., 1500° C. or 2000° C. in the presence of oxygen and/or a source of oxygen, preferably in the presence of magnesium or phosphor. Oxygen or a gas containing oxygen (e.g. atmospheric air) can be blown directly onto/into the powder. A releasing-oxygen compound may also be incorporated into the powder which, when heated, will release oxygen. Of course, the copper may be heated before being broken down to allow better oxidation. Copper can still be oxidized before the powder is broken down.

A particular embodiment of the present application concerns the means of storage, transport and/or biocide treatment of a liquid, paste or gel of the present invention, characterized in that the powder is comprised in a composite comprising a binder and optionally a curing catalyst agent.

A particular embodiment of the present application concerns the means of storage, transport and/or biocide treatment of a liquid, paste or gel, of the present invention, characterized in that the binder is an organic polymer selected from polyester, polyurethane, an epoxy polymer, vinyl ester or an inorganic polymer selected from silica, polydimethylsiloxanes, polythiazyles, polysilanes, polygermanes, preferably a silica polymer such as glass.

According to one embodiment of the present invention, the composite powder of (oxidized and/or phosphor) copper and the binder as defined above is characterized in that the proportion by weight of the powder composition/binder ranges from 1/2 to 2/1 respectively, preferably 1.275/1; 1/1.5 respectively, or for example 1/1.5 in the case of vinyl ester resins.

The composite powder of (oxidized and/or phosphor) copper and the binder of the present invention can be characterized in that the proportion by weight of the powder composition/binder is in the range of 1.1/1 to 1.5/1 respectively; 1.15/1 to 1.4/1, 1.2/1 to 1.35/1, 1.25/1 to 1.3/1, respectively, or is 1.275/1 respectively.

A particular embodiment of the present application concerns the means of transport of a liquid, paste or gel of the present invention characterized in that said means is a pipe or a tube, preferably of a round, oval, square or rectangular section. A particular embodiment of the present application concerns the means of transport of a liquid, paste or gel, of the present invention characterized in that the pipe is a pipeline. The pipe, tube or pipeline of the present invention can transport any liquid, paste of gel as defined in the present application.

A particular embodiment of the present application concerns the means of storage of a liquid, paste or gel of the present invention, selected from a tank, a reservoir, a basin, an open or closed container, such as a tank, silo, a ballast, a tray, a washtub, a bowl, a pot, a paste tube, a gel tube, a cream tube, a fuel tank, a bottle, a canteen or a drinking glass.

A particular embodiment of the present application concerns the means of storage of a liquid, paste or gel of the present invention, characterized in that it is a fuel tank for a vehicle such as a car, an airplane or a boat.

A particular embodiment of the present application concerns the means of biocide treatment of a liquid, paste or gel, of the present invention, characterized in that it consists in a filter comprising:
a chamber (1) with at least one entrance (2) and at least one exit (3) for the liquid, paste or gel to be treated to enter and leave said filter;
at least one passage way (4) to be in contact with the liquid, paste or gel being passed through the chamber (1), said passage way comprising the copper powder composition.

### FIGURES

FIG. 1 represents a filter comprising a chamber (1), one entrance (2) and one exit (3) for the liquid, gel or paste to pass through. The filter also comprises a number of sheets (5) coated with the coating of the present invention: there are thus several passages ways (4) which are in contact with the treated liquid, paste or gel. The flow (6) of liquid, gel or paste thus enters into the chamber (1) through the entrance (2), passes through the narrow passages (4) between the numerous sheets (5) wherein said liquid, gel or paste is in close contact with the coating of the invention, before being evacuated through the exit (3). Advantageously (3) is equal in size or more narrow than (2).

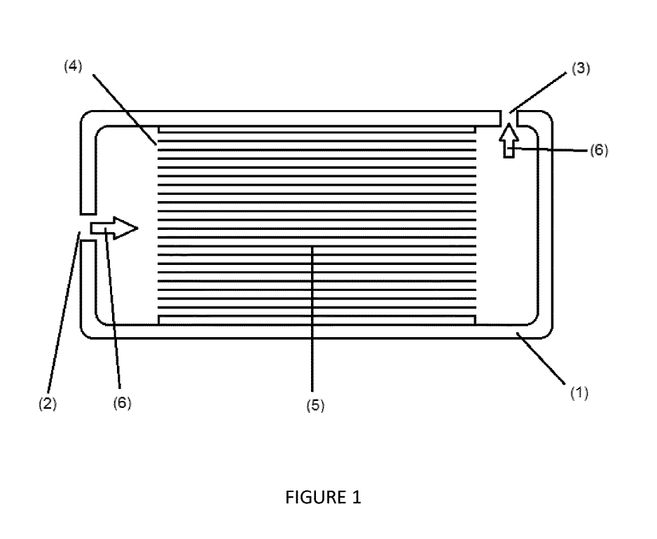

### EXAMPLES

To illustrate the present invention, the following examples were carried out.

1. Powder Containing CuP₈

CuP₈ powder, typically has the following characteristics: Nominal composition (wt %): Cu: 92% and P: 8%; Melting point: 710-750° C.; Density: 8 g/cm³.

According to the present invention, the copper-phosphorus alloy containing a percentage of phosphorus between 2 and 16% preferably 8% is introduced into the melting bath. The alloy is then water atomized so that the resulting particle size are between 8 and 150 μm (D50) and the oxygen content is between 0.3 and 5% by weight.
The following powder was obtained:

TABLE 1
cumulative % retained granularity (ISO4497)

| | | cumulative |
|---|---|---|
| particle | percentages | percentages |
| sizes | per slice | retained |
| ≧125 μm | 0.0 | 0.0 |
| ≧106 μm | 0.9 | 0.9 |
| ≧90 μm | 4.5 | 5.4 |
| ≧75 μm | 6.6 | 12.0 |
| ≧63 μm | 8.4 | 20.4 |
| ≧45 μm | 20.8 | 41.2 |
| <45 μm | 58.8 | 58.8 |
| Total | 100% | 100% |
| | | (41.2 + 58.8) |

Obtained density: 2.67 g/cm³ (ISO3923/2)
P % obtained 8.0% by weight

2. Powder Oxidized Copper

The same protocol as for the phosphorus-copper was applied to copper.

The following powder was obtained:

TABLE 2
cumulative % retained granularity (ISO4497)

| | | cumulative |
|---|---|---|
| particle sizes | percentages | percentages |
| particules | per slice | retained |
| ≧125 μm | 0.0 | 0.0 |
| ≧106 μm | 1.0 | 1.0 |
| ≧75 μm | 8.1 | 9.1 |
| ≧63 μm | 7.9 | 17.0 |
| ≧45 μm | 19.2 | 36.2 |
| <45 μm | 63.8 | 63.8 |
| Total | 100% | 100% |
| | | (36.2 + 63.8) |

Density obtained: 2.88 g/cm3
Oxygen rate “OR %” 0.35% by weight (ISO4491-4)

Then, the powder obtained is passed through a skelp furnace at a temperature above 500° C. (about 800° C. in this case under controlled atmosphere) which enables to oxidize the copper. An oxidized copper powder with the same particle size as above was obtained with a density of 1.60 g/cm³, a OR % of 0.08 wt % and a Cu %>99.7% by weight.

3. Examples of Composite/Coatings

The composites are obtained by simply mixing the compounds together (see Table 3). There can be a first step of sand blasting or grinding the surface to be treated (grain 120). If it is a metal surface, it is possible to apply an insulating primer and/or anticorrosion agent, adapted according to the nature of the substrate (ferrous, non-ferrous . . . ). In case of porous surfaces (stone, wood . . . ), it is possible to apply a polyester primer in two layers, if necessary with the sand blasting or grinding (grain 120) between the two. It is possible to apply the composite with a roll or a spray gun (in this case it is necessary to maintain a constant angle of projection on the surface of the composite at around 90° (±20°) for maximum covering). It is strongly advised to respect the curing time of the polyester primer (about 6 hours at 20° C. per layer) so that the thin layer persists over time. It can be then carried to drying with compressed air or by baking at 25° C. for 20 minutes. It is also possible to degrease the surface to be treated. Ideally, the coated substrate is treated in a controlled atmosphere room at 20° C. for 12 hours for effective curing. Once this curing period is complete, the sanding or grinding with a grain of 120 is performed again to remove the excess surface starch and oxides and/or to obtain a smooth metal-like surface, if required.

TABLE 3
examples of obtained composites

| | Composite 1 | Composite 2 | Composite 3 |
|---|---|---|---|
| metal powder | CuP₈ | Oxidized copper | Oxidized copper |
| | (powder Example 1) | (powder Example 2) | (powder Example 2) |
| Binder (mass | 84% polyester hybrid | Hybrid PoPolyester | Vynilester, ready to use |
| fractions | 8% acetone | 84% | commercial |
| | Styrene Parafiné 2% | 8% acetone | |
| | 4% dye | Styrene Parafiné 2% | |
| | | 4% dye | |
| Hardener (mass | Methyl Ethyl | Methyl Ethyl | |
| fractions) | Peroxide 2% | Peroxide 2% | |
| Mass fractions | Powder = 1.275 | Powder = 1.275 | Powder = 1 |
| of powder/ | Binder = 1 | Binder = 1 | Binder = 1.5 (estimated) |
| binder | | | |
| workable | Yes | Yes | Yes |
| suspension | | | |
| coating | spray | spray | spray |
| obtained | (possible with a roll) | (possible with a roll) | (possible with a roll) |
| Setting time | 60 minutes | 60 minutes | 60 minutes |
| Approximate | 100-250 microns | 100-250 microns | 100-250 microns |
| thickness of the | (estimated) | (estimated) | (estimated) |
| resulting | | | |
| coating | | | |

4. Examples of Biocide Activities and Fluids Movements Enhancement

The results of laboratory testing showed that the coatings had remarkable biocide properties (see the examples of FR1357099, FR1400766, and PCT EP2014/065498). Moreover, preliminary testing has revealed that the coatings of the present invention demonstrate high biocide properties (including anti-microbial) when exposed to various fluids such as water and several hydrocarbon base fluids (e.g. diesel). In particular, this activity has proven to be anaerobic. Therefore, the coatings of the present invention can be interestingly applied to supply chain elements: transport and storage of refined or crude oil such as in pipes, pipelines, tanks, etc, as the biocide activity should at least limit any bio-corrosion and e.g. stop the formation of sludge of biological origin in means of storage.

Furthermore, supplementary laboratory testing showed an increase in fluid flow rate over the entire surface covered with the coatings of the invention. Indeed, a substrate made of ordinary plastic was in one case coated with the coating of the invention (composite No 2 in table 3—copper oxidized at 99.9%) and in the other case only with the binder of composite No 2. A drop of fluid was deposited on each substrate at the same level and the two coated substrates were inclined with the same angle in respect to the horizontal (up to roughly 65°) in order to directly compare the speeds of the running down drops of fluids. This direct comparison enabled to establish that the coating of the present invention enabled an increase of speed of 10 to 30% in comparison to the binder alone. This inherent property of the coatings of the present invention (which seems to be linked to the presence of copper) enables to envisage a durable and costless way of saving energy expenditure when applied for means of supplies of various fluids, pastes or even gels.

1. Means of storage, transport and/or biocide treatment of a liquid, paste or gel, characterized in that said means comprises a copper base powder composition, said composition:
containing at least 60% by weight of copper,
does not contain more than 70% by weight of powder particles whose diameter is less than 45 μm maximum, and
is at least partially in contact with said liquid, paste or gel.

2. The means of storage, transport and/or biocide treatment of a liquid, paste or gel, according to claim 1, characterized in that the copper base powder composition is:
immobilized,
oxidized, preferably to the heart of the particles, and/or
comprises phosphor, preferably in the form of phosphorous copper such as CuP₈.

3. The means of storage, transport and/or biocide treatment of a liquid, paste or gel, as claimed in claim 2, characterized in that the oxidation of copper is greater than 95% by weight of oxidized copper vis-à-vis the total weight of copper and/or that the amount of phosphorus is between 2 and 16%, preferably 8%, by weight vis-à-vis the total weight of the powder composition.

4. The means of storage, transport, supply and/or biocide treatment of a liquid, paste or gel, according to any one of the preceding claims, characterized in that the powder is comprised in a composite comprising a binder and optionally a curing catalyst agent.

5. The means of storage, transport, supply and/or biocide treatment of a liquid, paste or gel, according to claim 4, characterized in that the binder is an organic polymer selected from polyester, polyurethane, an epoxy polymer, vinyl ester or an inorganic polymer selected from silica, polydimethylsiloxanes, polythiazyles, polysilanes, polygermanes, preferably a silica polymer such as glass.

6. The means of storage, transport, supply and/or biocide treatment of a liquid, paste or gel, according to any one of the preceding claims, characterized in that the composition of copper powder is comprised in a surface coating.

7. The means of storage, transport and/or biocide treatment of a liquid, paste or gel, according to any one of the preceding claims, characterized in that the liquid, paste or gel is organic and/or inorganic, preferably food and/or beverages or intended for pharmaceutical purposes, cosmetic purposes or fuel, preferably selected from crude or refined oil, water, fuel for vehicles such as diesel fuel, kerosene or unleaded fuel.

8. The means of storage, transport and/or biocide treatment of a liquid, paste or gel, according to any one of the preceding claims, characterized in that said means is a pipe or a tube, preferably of a round, oval, square or rectangular section.

9. The means of storage, transport and/or biocide treatment of a liquid, paste or gel, according to claim 8, characterized in that the pipe is a pipeline.

10. The means of storage, transport and/or biocide treatment of a liquid, paste or gel according to any one of claims 1 to 7, selected from a tank, a reservoir, a basin, an open or closed container, such as a tank, silo, a ballast, a tray, a washtub, a bowl, a pot, a paste tube, a gel tube, a cream tube, a fuel tank, a bottle, a canteen or a drinking glass.

11. The means of storage, transport and/or biocide treatment of a liquid, paste or gel according to claim 10, characterized in that said means of transport, supply and/or storage is a tanker vehicle such as a boat, airplane, truck or trailer or is a fuel tank for a vehicle such as a car, airplane, bus, truck or boat.

12. The means of biocide treatment of a liquid, paste or gel, according to claims 1 to 9 characterized in that it comprises a filter comprising:
a chamber (1) with at least one entrance (2) and at least one exit (3) for the liquid, paste or gel to be treated to enter and leave said filter;
at least one passage way (4) to be in contact with the liquid, paste or gel being passed through the chamber (1), said passage way comprising the copper powder composition.

13. Use of the means of storage, transport and/or biocide treatment according to any one of claims 1 to 12 for reducing the population of microorganisms contained in a liquid, paste or gel, preferably to sterilize said liquid, paste or gel, or to ensure said liquid, paste or gel is sterile.

14. Use of the means of transport of a liquid, paste or gel according to any one of claims 4 to 9, to increase the transport speed of said liquid, paste or gel, as compared to a transport means which does not use such a composite or coating with the same energy expenditure.

15. Use of the means of transport of a liquid, paste or gel according to any one of claims 4 to 9 to reduce the expenditure of energy associated with the flow of said liquid, paste or gel, compared with a transport means which does not use such a coating or composite.
